(19) United States
(12) Patent Application Publication
(10) Pub. No.: US 2016/0330984 A1
(43) Pub. Date: Nov. 17, 2016

(54) Method of treating fruit Pressing residue

(71) Applicant: Werner Tomasi, Boozen (IT)

(72) Inventor: Werner Tomasi, Boozen (IT)

(21) Appl. No.: 15/109,454

(22) PCT Filed: Dec. 30, 2014
(86) PCT No.: PCT/IB2014/003242

§ 371 Date: Jul. 1, 2016

(30) Foreign Application Priority Data
Jan. 3, 2014 (DE) 10 2014 100 032.3

(51) Int. Cl. A23B 7/005; A23B 7/04; B09B 3/00; A23B 7/024

(52) U.S. Cl. CPC A23B 7/0053; A23B 7/024; A23B 7/0408; B09B 3/0083; A23V 2002/00; F26B 2200/02

(57) ABSTRACT

A method of treating fruit pressing residue to avoid formation of germ-buds and mold, more particularly aflatoxins, is disclosed. The treatment includes storing fruit pressing residue (pomace) at a controlled temperature, and calibrating the residue to a homogeneous size. In a first step the fruit pressing residue is heated at a temperature between 150° C. and 200° C. for a period between 30 and 60 minutes. During this step sterility is achieved by the killing off of any microbes, fungal spores or germ-buds. In a second step the residue is then aerated with dry-filtered air with a temperature between −15° C. and −50° C. for a period between 15 and 60 seconds. The final moisture vapors are thereby removed. In a third step the fruit pressing residue is cooled by dry-filtered ice air with a temperature between −15° C. and −50° C. for a period between 1 minute and 15 minutes.

### TECHNICAL FIELD

The present invention concerns a method of treating the residue (waste) from the pressing of fruit.

### BACKGROUND

Treatment methods are used to change the dangerousness of components in fruit pressing waste and convert hazardous waste into non-hazardous waste. Waste is regarded as stabilized if after successful treatment, hazardous ingredients are fully converted into non-hazardous ingredients before they could be released into the environment.

With conventional methods of treating wastes, harmful ingredients of dangerous wastes are chemically converted (stabilized) by the addition of suitable additives, thereby converting hazardous into non-hazardous waste. In successful cases, the waste can then be recycled at appropriate landfills or used as construction material.

The disadvantage of chemically treating wastes is particularly to be seen in that treating wastes is to be regarded as chemical treatment with the goal of material transformation which should achieve the elimination of the potential hazard.

### SUMMARY

The present disclosure provides a method of treating fruit pressing residue (pomace) which eliminates the aforementioned disadvantages and which eliminates the use of chemical substances and thus prevents an accompanying material transformation of the pomace.

The presented method teaches that fruit pressing residue is stored at a controlled temperature after the pressing to avoid formation of germ-buds and mold, inter alia of aflatoxins. After that, any lumps or clumps are calibrated in order to achieve a homogeneous size, which leads to better results, since with different calibration, the treatment method is not performed properly and thus sterility cannot be achieved.

The treatment method is characterized by the following further process steps:

a) Treatment step 1: Heating the fruit pressing residue to a temperature between 150° C. and 200° C. for a period between 30 and 60 minutes. During this process, sterility is achieved by killing off any microbes, fungal spores or germ-buds.

b) Stabilizing step 2: Aerating the fruit pressing residue by means of dry-filtered air with a temperature between −15° C. and −50° C. for a period between 15 and 60 seconds. The final moisture vapors are thereby removed in preparation for the following stabilizing step 3.

c) Stabilizing step 3: Cooling the fruit pressing residue by means of dry-filtered ice air with a temperature between −15° C. and −50° C. for a period between 1 minute and 15 minutes.

### BRIEF DESCRIPTION OF THE DRAWINGS

Further goals, features, advantages, and application possibilities of the disclosed treatment method result from the following description of an embodiment example on the basis the drawing.

FIG. 1 is a schematic view of a device which implements a method of treating fruit pressing residue.

### DETAILED DESCRIPTION

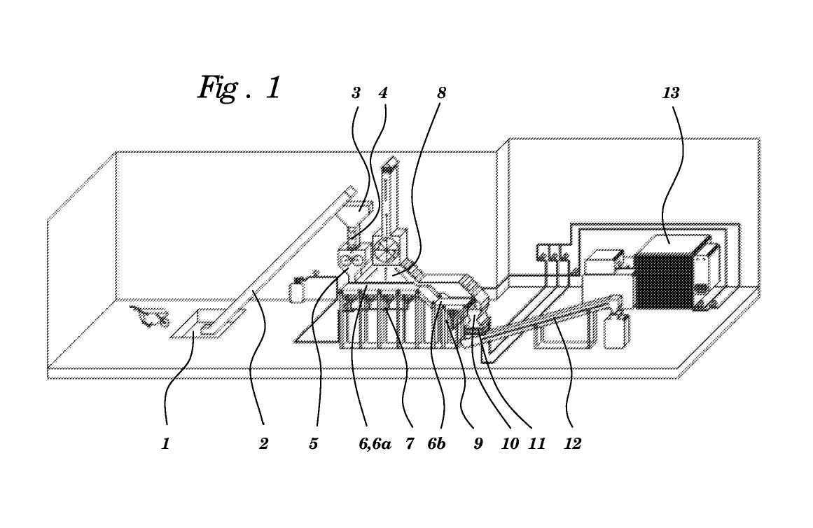

Referring to FIG. 1, a device for performing a method of treating fruit pressing residue comprises at least a storage tray 1 for the stockpiling of fruit pressing residue at a controlled temperature.

By means of a transport screw 2, the fruit pressing residue is led to a throw-in socket 3 with coupled shaker 4. Calibration rolls 5 are arranged below it for calibrating the fruit pressing residue. The fruit pressing residue is then transferred onto at least one, preferably micro-porous, conveyor belt 6 which comprises a first section 6a and a second section 6b.

The calibrated fruit pressing residue is heated under adjustable heat by means of a heating device 7 with a temperature between 150° C. and 200° C. on the first conveyor belt section 6a, wherein the heating process takes place for a period of 30 to 60 minutes. Humidity is extracted by means of a humidity extraction hood 8 during the heating process.

In a further step, the heated and dehumidified fruit pressing residue is passed on to a cooling device 9 through which in a controlled manner dry-filtered air with a temperature between −15° C. and −50° C. is fed and pre-cooled for a period between 15 and 60 seconds. By means of the humidity extraction hood 8, preferably also arranged over this second conveyor section 6b, all remaining humidity is extracted from the fruit pressing residue.

The fruit pressing residue processed so far is cooled by means of the conveyor belt 6 now in a collection device 10 by means of double-layered cooling process and then reaches a loading container 11 where it is fully cooled by means of a transport screw 12 with integrated cooling system to a temperature between −15° C. and −50° C. for a period between 1 minute and 10 minutes. An ice ventilation system 13 is provided for the cooling of the transport screw section 12.

The advantages of the treatment method of fruit pressing residue can be divided in three groups:

1. When processing toxic organic waste, so-called “aflatoxins” (Aspergillus) can form in the raw state after the pressing under the right circumstances, wherein at least 20 naturally occurring aflatoxins which are considered very dangerous for humans can be distinguished here. Aflatoxin B1 is one of the strongest carcinogenic compounds. Through the method of treating fruit pressing residue, this aflatoxin cannot come about and the end product is thus regarded as sterile and stable.

2. Through the method of treating fruit pressing residue, a basic product is produced, which can be used in many areas and which possesses many positive characteristics: Sterility, stability, absence of flammability, pleasant smell, etc.

3. Through a further method, energy can be generated from the basic product and its processing remains and the use cycle can thus be completely concluded.

The method of treating fruit pressing residue can be used to produce a basic product that is predominantly found in building industry use, e.g., as insulating filling or replenishment for isolation walls. Further areas of use are also possible. In contrast to frequently used cork granulate, the basic products then have the following advantages: No flammability, strength in structural stability, no volume loss and loadable. In contrast to wood fibers, which are only available in panel form, the following advantages arise, in addition to those named above: no chemical components (compound materials), little to no smoke formation.

The treatment process according to the invention is not limited in its execution to the preferred embodiments described above. Instead, a variety of embodiment variations are possible, which make use of the presented solution, even in fundamentally different design.

### LIST OF REFERENCE NUMBERS

1 Storage tray
2 Transport screw
3 Throw-in socket
4 Shakers
5 Calibration rolls
6 Conveyor belt
6a, 6b Conveyor belt sections
7 Heating device
8 Humidity extraction hood
9 Cooling device
10 Collection device
11 Loading container
12 Transport screw
13 Ice ventilation system

1.-5. (canceled)

6. A method of treating fruit pressing residue to avoid formation of germ-buds, mold, and aflatoxins, comprising:
calibrating the fruit pressing residue to a homogeneous size;
heating the fruit pressing residue to a temperature between 150° C. and 200° C. for a period between 30 and 60 minutes whereby microbes, fungal spores, and germ-buds are killed off;
aerating the fruit pressing residue with dry-filtered air with a temperature between −15° C. and −50° C. for a period between 15 and 60 seconds whereby moisture vapors are removed; and
cooling the fruit pressing residue by dry-filtered ice air with a temperature between −15° C. and −50° C. for a period between 1 minute and 15 minutes.

7. A device for performing the method as in claim 6, comprising:
at least one storage tray (1) for stockpiling of fruit pressing residue;
a transport screw (2) arranged between the storage tray and a throw-in socket (3);
a shaker (4) coupled to the throw-in socket (3);
calibration rolls (5) arranged below the shaker (4); and
at least one conveyor belt (6).

8. The device as in claim 7, further comprising:
a heating device (7) provided at a first section (6a) of the conveyor belt (6) and at least one humidity extraction hood (8) which extracts humidity during the heating of the fruit pressing residue.

9. The device as in claim 8, further comprising
a cooling device (9) provided at a second section (6b) of the conveyor belt (6) for performing the aerating of the fruit pressing residue,
wherein the humidity extraction hood (8) extends above the second section (6b) of the conveyor belt section (6).

10. The device as in claim 7, further comprising
a collection device (10), a loading container (11), and a transport screw (12) for performing the cooling of the fruit pressing residue.
